(19) United States
(12) Patent Application Publication
(10) Pub. No.: US 2004/0245745 A1
(43) Pub. Date: Dec. 9, 2004

(54) Human powered golf cart with auxiliary power source

(76) Inventor: Paul M. Vasser, Aptos, CA (US)

Correspondence Address: Richard C. Litman, Crystal City Station, P.O. Box 15035, Arlington, VA, 22215-0035, US

(21) Appl. No.: 10/867,773

(22) Filed: Jun. 16, 2004

Related U.S. Application Data
(62) Division of application No. 10/350,117, filed on Jan. 24, 2003.

(51) Int. Cl. B62K 5/00

(52) U.S. Cl. 280/282

(57) ABSTRACT

A human powered golf cart with an auxiliary power source. There are several embodiments of the invention to accommodate one and two users with both a tricycle chassis, a quadracycle chassis and a bicycle chassis and bodies. A horizontal platform is attached to the back axle of the tricycle chassis and body and a single wheel cart is attached to a bicycle chassis and body. An auxiliary power source in the form of an electric battery and a chain driven electric motor is provided to supplement any power provided by the user(s).

### BACKGROUND OF THE INVENTION

1. Field of the Invention

The present invention relates to a human powered golf cart with an auxiliary power source. The invention can be in the form of a quadracycle, a tricycle or a bicycle and can accommodate one or two riders.

2. Description of the Related Art

Golfing is one of America's favorite past times. Although originally designed to be done on foot, modern day golfers can choose to use a golf cart to transport them and their golf bags on the golf course. Most of these golf carts are electrically powered and are designed for persons who want to golf, but do not want to walk on foot from shot to shot. These golf carts are well-known and reflected in the related art.

U.S. Pat. No. 2,973,048 issued to Jensen, outlines the use of a three wheeled motorized golf vehicle. The self-propelled vehicle is used to transport golfers and their equipment about a golf course. The self-propelled vehicle is made up of a chassis and body that cooperate to support golfers and their equipment.

U.S. Pat. No. 3,117,648 issued to Landreth, outlines the use of an electrically-powered vehicle having interconnected power and brake controls. The vehicle is small, relatively light and highly maneuverable and can also be used for industrial transportation between buildings as well as being used on a golf course.

U.S. Pat. No. 3,605,929 issued to Rolland, outlines the use of a three-wheel cart made up of three sub-assemblies designed to be easily assembled and disassembled. This includes a front steering fork assembly detachably connected by a withdrawable king-pin, with the front end of the front frame assembly, on which a driver's seat is carried, and a rear frame assembly pivotally and detachably connected to the rear end of the front frame assembly.

U.S. Pat. No. 3,777,836 issued to Riza, outlines a one man golf cart that is assembled from seven basic structures. The seven basic structures include an L-shaped frame, a receptacle on the back and lower end of the L-shaped frame, in which a golf bag is placed, two removable rear wheels.; a removable seat, a means for supporting the upper end of the golf ,bag and a front wheel supported by a structure adapted to secure the front end of the L-shaped frame.

U.S. Pat. No. 3,815,699 issued to Ganskopp et al., outlines the use of a cart that is lightweight and portable and may be easily disassembled for transporting from one place to another. The cart includes an elongated control frame and a drive frame, which is removably connected to the control frame and carries an electric motor and battery for driving the cart in front of the user so that the cart may be used in pacing the walking speed of the user. The control frame also includes a front guide wheel for supporting the front portion of the cart, so that it may move along unattended by the user, except for changing direction.

U.S. Pat. No. 4,113,043 issued to Palmer, outlines the use of a two or more wheeled vehicle driven by a DC electric motor having its output shaft connected to a frictional drive member which bears on the circumference of a driven wheel. The drive motor is face or flange mounted on a mounting bracket, which is constructed of a metal stamping or an integral combination of two stampings. U.S. Pat. No. 4,387,836 issued to Laesch, outlines the use of a golf bag carrier for an adult-sized pedal-powered tricycle or quadra-cycle, including tubular axle housing portions enclosing opposite ends of the rear axle. The carrier includes an elongated golf bag supporting frame member having an upstanding rectilinear portion substantially co-extensive with most of the height of the golf bag and a base portion underlying the golf bag. The base portion also carries a support pedestal for supporting the golfbag.

U.S. Pat. No. 4,848,504 issued to Olson, outlines the use of a walking or riding power driven golf cart. The golf cart is collapsible so that it may be used selectively in walking and riding modes and is collapsible for storage and transport in the

U.S. Pat. No. 5,307,889 issued to Bohannan, outlines the use of a golf cart or personal utility vehicle which includes a wheeled platform, a wheeled gooseneck frame detachably secured at the rear of the platform and a detachable steering handle for turning a powered wheel on the gooseneck frame for steering purposes. A detachable upright post provides support for a conventional golf-bag and set of clubs. A forwardly facing occupant seat is detachably mounted to the gooseneck frame, placing the weight of an occupant upon the rear driving and steering wheel.

U.S. Pat. No. 5,482,304 issued to Smith, outlines the use of a trailering device for being secured between a bicycle and a pull-type golf cart, such that as the bicycle is ridden, the pull-type golf cart is pulled behind. The trailering device includes a connecting rod, a bicycle attachment member secured at one end of the connecting rod and a golf cart attachment member secured to another end of the connecting rod.

U.S. Pat. No. 5,727,642 issued to Abbott, outlines the use of a golf cart for persons who are obliged to traverse a golf course in a cart, which includes a golf bag carrier mechanism, steering assembly and adjustable seat to enable the person to swing a golf club without interference with any of these mentioned components. The seat may be rotated in either direction from the traversing axis of the cart, to enable the person to face a golf ball to be struck.

Although each of these patents outline devices that are novel and useful, there is still room for improvement for golf cart devices. A golf cart device that can provide alternative transportation for golfers that can't walk, but would want to continue to exercise while playing golf, could be in demand. Such a device could be well received in the marketplace.

None of the above inventions and patents, taken either singularly or in combination, is seen to describe the instant invention as claimed. Thus a human powered golf cart with auxiliary power source solving the aforementioned problems is desired.

### SUMMARY OF THE INVENTION

The invention is a human powered golf cart with an auxiliary power source. There are several embodiments of the invention to accommodate one and two users, with both a tricycle, a bicycle and quadracycle chassis and body. A horizontal platform is attached to the back axil of the tricycle and the quadracycle chassis and body and a single wheel cart is attached to a bicycle chassis and body. An auxiliary power source, in the form of an electric battery and a chain driven electric motor, is provided to supplement any power provided by the user(s).

Accordingly, it is a principal object of the invention to provide a golf cart that provides human driven transportation for golfers that can't walk long distances, but would still want to get some other kind of exercise while playing golf.

It is another object of the invention to provide a human powered golf cart that has an auxiliary electric power source that is available when needed.

It is a further object of the invention to provide a human powered golf cart that is lightweight and maneuverable, so that it can be easily negotiated on cart paths and fairway roughs.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of the first embodiment of a human powered golf cart with, an auxiliary power source according to the present invention.

FIG. 2 is an exploded perspective view of the first embodiment of a human powered golf cart with an auxiliary power source.

FIG. 3 is an environmental perspective view of the second embodiment of a human powered golf cart with an auxiliary power source.

FIG. 4 is an environmental perspective view of the third embodiment of a human powered golf cart with an auxiliary power source.

Similar reference characters denote corresponding features consistently throughout the attached drawings.

### DETAILED DESCRIPTION OF THE PREFERRED EMBODIMENTS

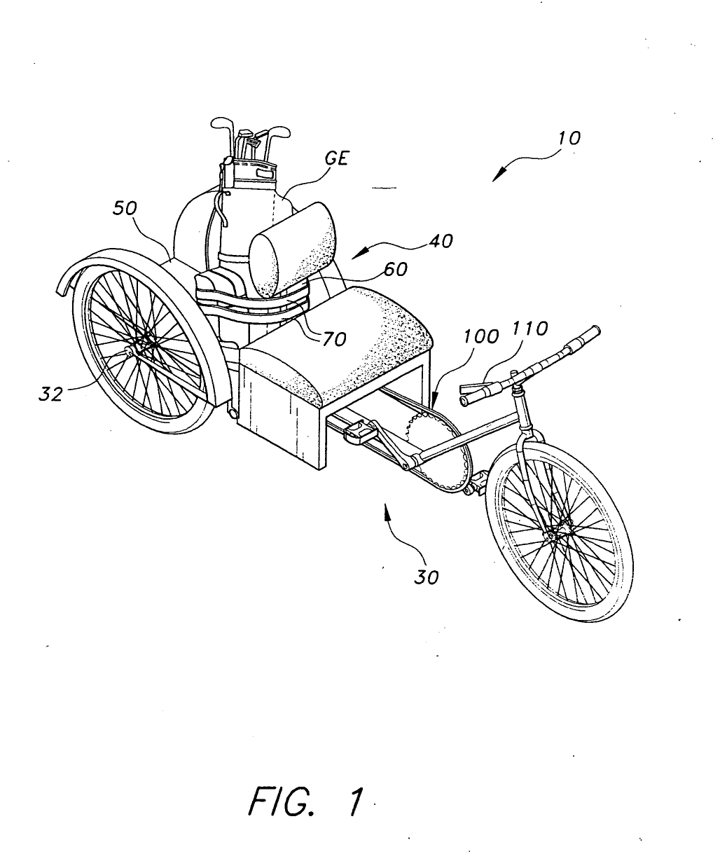

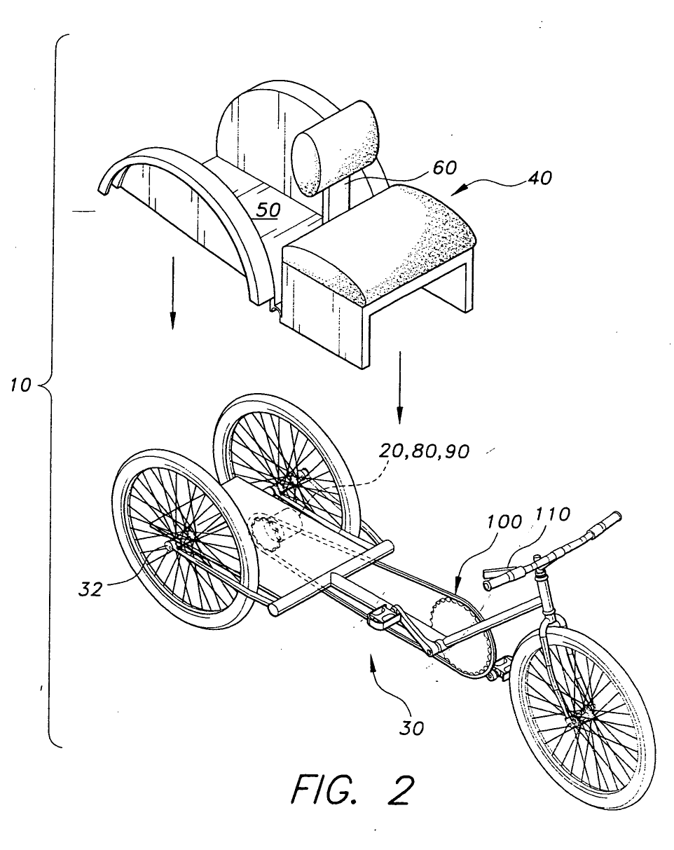

The present invention is a human powered golf cart for a single user 10, with an auxiliary power source 20, as is shown in FIG. 1 and FIG. 2. The first embodiment of a human powered golf cart for a single user 10 comprises a tricycle chassis 30 and a body 40, to be pedaled by a single user (not shown) to generate power to transport the single user and the first embodiment of the human powered golf cart for a single user 10. The first embodiment of the human powered golf cart for a single user 10 also includes a horizontal platform 50 attached to a back axil 32 of the tricycle chassis 30 and body 40, to set any golfing equipment GE on. There is also a vertical support 60 that is perpendicularly attached to the horizontal platform 50. The vertical support 60 is provided with a plurality of straps 70 to secure any golfing equipment GE to the horizontal platform 50 and the vertical support 60, the auxiliary power source 20 being an electric battery 80 and a chain driven electric motor 90 to supplement any power provided by the user

The human powered golf cart for a single user 10 utilizing the body 40 of a tricycle is made of lightweight fiberglass. The chassis 30 itself is actually a modified tricycle. The human powered golf cart for a single user 10 also has a chain driven pedal mechanism 100 as well as a 36 volt electric battery 80 and can individually operate the human powered golf cart for a single user 10 approximately 8-10 miles per charge. The chain driven pedal mechanism 100 also utilizes an electric chain driven motor 90 for the back wheels of the human powered golf cart for a single user 10. The human powered golf cart for a single user 10 also has an electric power assist lever 110, located on the right lower handlebar, to activate the electric battery 80 and the auxiliary power source 20.

The human powered golf cart for a single user 10 is one of three embodiments. The other embodiments are described in the subsequent details of this section of the application and include a human powered golf cart (quadracycle) for two users 120, a human Powered golf cart (bicycle) for a single user 130 and a human powered golf cart (tricycle) for one user 10.

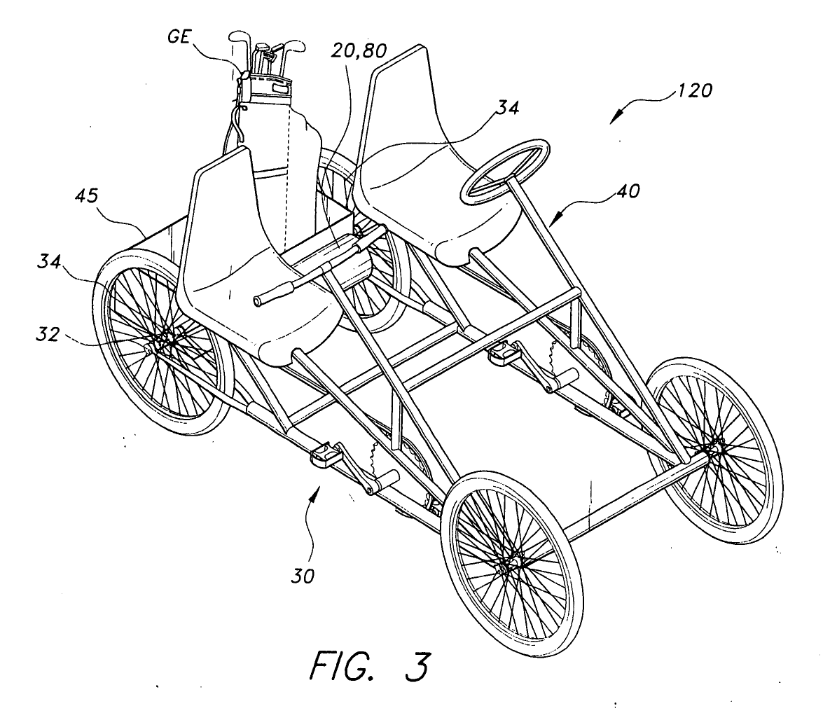

The second embodiment of this invention is a human powered golf cart (quadracycle) for two users 120, as is depicted in FIG. 3. The human powered golf cart (quadracycle) for two users 120, with an auxiliary power source 20, comprises a quadracycle chassis 30 and a body 40 to be pedaled by the two users, to generate power to transport the two users and the human powered golf cart (quadracycle) for two users 120. There is also an open top box 45 attached to the back axil 32 of the quadracycle chassis 30 and body 40, to set any golfing equipment GE into. The open top box 45 is provided with the human powered golf cart (quadracycle) for two users 120, as opposed to the vertical support 60, the horizontal platform 50, and the plurality of straps 70. The open top box 45 is situated between the two back wheels 34 and can hold more equipment then the bicycle and tricycle embodiments 10,130 with the human powered golf cart (quadracycle) for two users 120. The open top box 45 has high enough walls so that no plurality of straps 70 are needed to secure any golfing equipment GE. The open top box 45 can comfortably allow any golfing equipment GE to rest upright against one of the walls of the open top box 45. The auxiliary power source 20 for a human powered golf cart (quadracycle) for two users 120 is an electric battery 80 and a chain driven pedal mechanism 100 to supplement any power provided by the two users.

The body 40 of the human powered golf cart (quadracycle) for two users 120 is made of lightweight fiberglass, while its quadracycle chassis 30 has a chain driven pedal mechanism 100. The human powered golf cart (quadracycle) for two users 120 has a 36 volt electric battery 80 and can operate 8-10 miles per charge. An electric power assist lever 110 is also used to activate the auxiliary power source 20.

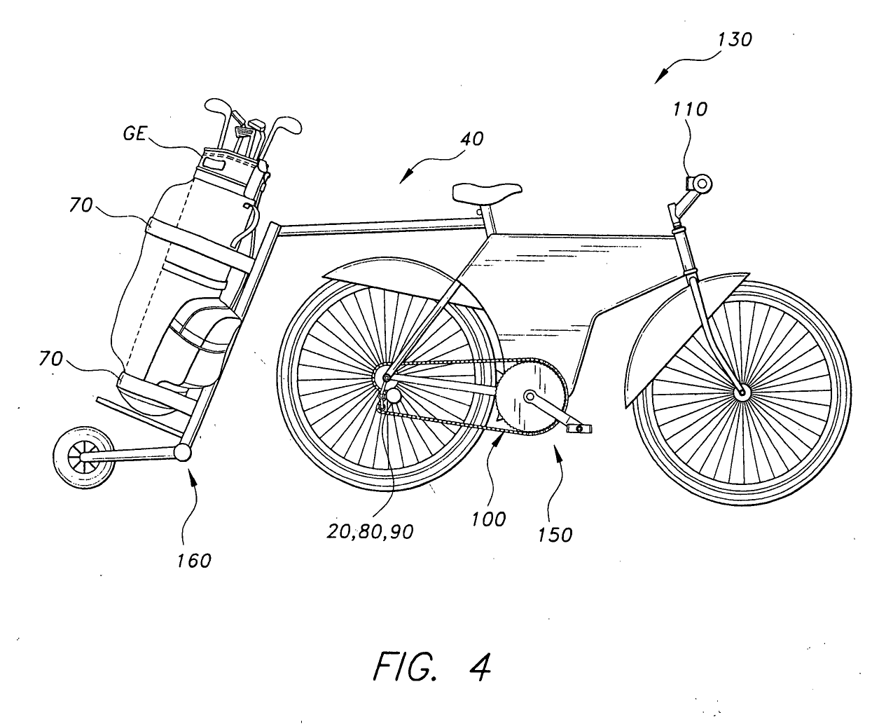

FIG. 4 outlines the use of a human powered golf cart (bicycle) for a single user 130, with an auxiliary power source 20. The human powered golf cart (bicycle) for a single user 130 comprises a bicycle chassis 150 and a body 40 to be pedaled by a single user, to generate power to transport the single user and the human powered golf cart (bicycle) for a single user 130. A single wheel cart 160 is attached to the bicycle chassis 150 and the body 40 to set any golfing equipment GE on. The single wheel cart 160 is also provided with a plurality of straps 70 to secure any golfing equipment GE to the single wheel cart 160, while an electric battery 80 serves as the auxiliary power source 20 for a chain driven electric motor 90 to supplement any power provided by the user.

The human powered golf cart (bicycle) for a single user 130 is strong and durable, with the body 40 being made of lightweight 100 that the user can utilize to power this embodiment. The human powered golf cart (bicycle) for a single user 130 also utilizes a 36 volt electric battery 80 and can operate 8-10 miles per charge. An electric power assist lever 110, located on the right front handlebar, is also used to activate this auxiliary power source 20.

Any embodiment of the invention 10,120,130 will encourage golfer(s) who need to use a golf cart, to serve as an alternative to a regular electric powered golf cart. Any embodiment of the invention 10,120,130 will encourage a healthier alternative to riding in a regular electric powered golf cart. Support for providing an alternative way of exercising, while playing golf, will be good public relations and positive publicity for any golf course. Any embodiment of the invention 10,120,130 is lightweight and maneuverable, so that it can be easily negotiated around cart pathways and fairway roughs.

It is to be understood that the present invention is not limited to the embodiments described above, but encompasses any and all embodiments within the scope of the following claims.

1-5 (Canceled)

6. A human powered golf cart for two users, with an auxiliary power source comprising:
a quadracycle chassis and a body to be pedaled by the two users to generate power to transport the two users and the human powered golf cart (quadracycle) for two users;
an open top box attached to a back axil of the quadracycle chassis and the body to set any golfing equipment into;
said auxiliary power source being an electric battery and a chain driven electric motor to supplement any power provided by the two users.

7. The golf cart according to claim 6, wherein the body is made of lightweight fiberglass.

8. The golf cart according to claim 6, wherein the chassis has a chain driven pedal mechanism.

9. The golf cart according to claim 6, wherein the electric battery is 36 volts and can operate 8-10 miles per charge.

10. The golf cart according to claim 6, wherein an electric power assist lever is used to activate the auxiliary power source.

11-15 (Cancelled)
